(19) United States
(12) Patent Application Publication
(10) Pub. No.: US 2017/0096154 A1
(43) Pub. Date: Apr. 6, 2017

(54) Locomotive Control Signal Generator

(71) Applicant: Westinghouse Air Brake Technologies Corporation, Wilmerding, PA (US)

(72) Inventor: Ryan Paul Hurst, Lee's Summit, MO (US)

(21) Appl. No.: 15/277,275

(22) Filed: Sep. 27, 2016

Related U.S. Application Data
(60) Provisional application No. 62/236,556, filed on Oct. 2, 2015.

(51) Int. Cl. B61L 27/00; G09B 9/04; B61L 25/02

(52) U.S. Cl. CPC B61L 27/0055; B61L 27/0038; B61L 25/025; G09B 9/04; B61L 2201/00

(57) ABSTRACT

A locomotive control signal generator includes emulation circuitry for emulating at least one operation of at least one locomotive control circuit. The emulation circuitry is programmed or configured to determine or receive user input and based at least partially on the user input, generate at least one control signal for controlling at least one of the following onboard locomotive subsystems: a propulsion system, a train line control system, an air brake system, a dynamic braking system, a head of train (HOT) system, an end of train telemetry (EOT) system, a 4-Aspect cab signaling system, a positive train control (PTC) system, an event recorder system, or any combination thereof.

### CROSS REFERENCE TO RELATED APPLICATIONS

This application claims the benefit of priority from U.S. Provisional Patent Application No. 62/236,556, entitled “Locomotive Control Signal Generator” and filed Oct. 2, 2015, which is incorporated herein by reference in its entirety.

### BACKGROUND OF THE INVENTION

Field of the Invention

Disclosed embodiments relate generally to locomotive control signal generation, and in particular to a locomotive control signal generator and method that provides emulation of a locomotive control circuit, such as in connection with locomotive training and locomotive testing.

Description of Related Art

Locomotive operators and repair personnel typically receive some type of training on how locomotives function and operate. Theoretical training on the function and operation of locomotives can provide only a limited level of knowledge transfer to a student. Practical training on an actual locomotive can provide a more advanced level of knowledge transfer and/or more hands-on experience to the student, but has disadvantages of increased safety and cost risks.

Locomotive simulators have been created in an attempt to provide operators with more practical training without incurring the safety and cost risks associated with training on an actual locomotive. However, conventional locomotive simulators are directed primarily at the locomotive operator and do not deliver physical signals to actual onboard locomotive hardware and subsystems. Conventional locomotive simulators instead focus more on the track layout and operator interaction regarding controlling the train during simulated train operations. Consequently, conventional locomotive simulators are not suitable for training mechanical repair personnel or for performing locomotive hardware and subsystems testing. For example, conventional locomotive simulators cannot provide an indication of how a positive train control (PTC) system and an event recorder system behave on an actual operational locomotive during revenue service.

Furthermore, conventional hardware racks for testing locomotive hardware can only test individual locomotive control circuits one at a time. Conventional hardware racks cannot test a combination of circuits that can be actuated together, such as during operation of an actual locomotive in revenue service. This can cause a defect to go undetected during a test and, thus, the locomotive hardware not receiving proper repair.

For at least these reasons, there is a need in the art for an improved locomotive control signal generator for locomotive training and testing purposes.

### SUMMARY OF THE INVENTION

Generally, provided are an improved locomotive control signal generator and computer-implemented method for emulating at least one operation of at least one locomotive control circuit. Preferably, provided are a locomotive control signal generator and computer-implemented method that enable various rail hardware and systems that monitor locomotive control system signals to be placed in normal locomotive operation without an actual locomotive being required. Preferably, provided are a locomotive control signal generator and computer-implemented method that provide onboard locomotive hardware and subsystems, such as positive train control (PTC) and event recorder systems, locomotive control system signals that can be generated in a controlled environment. Preferably, provided are a locomotive control signal generator and computer-implemented method that reduce safety and cost risks associated with training personnel on the functions and operations of locomotives. Preferably, provided are a locomotive control signal generator and computer-implemented method that can omit or modify locomotive logic during operation with regard to any and all signal output drive logic to simulate locomotive failures, which can greatly enhance training by enabling users to troubleshoot the system in which they are receiving training. Preferably, provided are a locomotive control signal generator and computer-implemented method that enable a user to replicate conditions that were present on a locomotive at a time of failure, which allows confirmation of defects to ensure proper diagnosis of problems so that causes of the problem can be addressed and documented.

In one preferred and non-limiting embodiment or aspect, provided is a locomotive control signal generator comprising: emulation circuitry for emulating at least one operation of at least one locomotive control circuit, wherein the emulation circuitry is programmed or configured to: determine or receive user input; and based at least partially on the user input, generate at least one control signal for controlling at least one of the following onboard locomotive subsystems: a propulsion system, a train line control system, an air brake system, a dynamic braking system, a head of train (HOT) system, an end of train telemetry (EOT) system, a 4-Aspect cab signaling system, a positive train control (PTC) system, an event recorder system, or any combination thereof.

In one preferred and non-limiting embodiment or aspect, the emulation circuitry is programmed or configured to determine or receive at least one output signal from the at least one onboard locomotive subsystem. In another preferred and non-limiting embodiment or aspect, the emulation circuitry is programmed or configured to generate the at least one control signal based at least partially on the at least one output signal. In another preferred and non-limiting embodiment or aspect, the at least one output signal comprises data representing an event recorder file. In a further preferred and non-limiting embodiment or aspect, the emulation circuitry is programmed or configured to replicate conditions present in one or more locomotive control circuits of a locomotive at a selected period of time based at least partially on the data representing the event recorder file. In a still further preferred and non-limiting embodiment or aspect, the conditions include at least one error or failure condition of the one or more locomotive control circuits of the locomotive. In another preferred and non-limiting embodiment or aspect, the at least one output signal comprises data representing a track database file. In a further preferred and non-limiting embodiment or aspect, the emulation circuitry is programmed or configured to generate the at least one control signal in a National Marine Electronics Association (NMEA) format based at least partially on the data representing the track database file.

In one preferred and non-limiting embodiment or aspect, the emulation circuitry is programmed or configured to generate the at least one control signal as one of a digital signal, an analog signal, a frequency signal, and a serial communications signal.

In one preferred and non-limiting embodiment or aspect, the emulation circuitry is programmed or configured to modify the emulation of the at least one operation of the at least one locomotive control circuit to simulate at least one failure of the locomotive control circuit.

In one preferred and non-limiting embodiment or aspect, the emulation circuitry simultaneously emulates operations of a plurality of locomotive control circuits, and wherein the emulation circuitry is programmed or configured to generate a plurality of control signals for controlling a plurality of onboard locomotive subsystems.

In one preferred and non-limiting embodiment or aspect, the emulation circuitry is programmed or configured to provide a user interface configured to determine or receive the user input and provide an output of locomotive operational information. In another preferred and non-limiting embodiment or aspect, the user interface comprises at least one emulated locomotive control configured to be actuated by a user. In another preferred and non-limiting embodiment or aspect, the at least one emulated locomotive control comprises at least one of the following: a master controller reverser position control, a master controller throttle position control, an automatic brake control, an independent brake control, a feed valve settings control, an air brake cut in and cut out actuation control, an engine control switch, a cab signal cut in and cut out switch, a cab signal depart test switch, a horn switch, a generator field switch, an engine run switch, a wheel slip test switch, a manual sand switch, an alerter reset switch, or any combination thereof. In a further preferred and non-limiting embodiment or aspect, the output of locomotive operational information comprises at least one of the following: at least one emulated air brake gauge indicating at least one of a main reservoir pressure, a brake pipe pressure, an equalizing reservoir pressure, and a brake cylinder pressure, an emulated load meter, an emulated 4 aspect cab signal display, an emulated head of train device with read out, an emulated speedometer, an emulated wheel slip indicator, an emulated process control system (PCS) open indicator, or any combination thereof. In a still further preferred and non-limiting embodiment or aspect, the emulation circuitry comprises a processor configured to control a display to provide the user interface to the user and execute locomotive logic to emulate the at least one operation of the at least one locomotive control circuit and at least one programmable logic controller (PLC) configured to drive the at least one locomotive control subsystem with the at least one control signal based at least partially on the emulation of the at least one operation of the at least one locomotive control circuit.

In one preferred and non-limiting embodiment or aspect, the at least one control signal comprises at least one of i) movement data representing at least one of the following: an emulated speed of the locomotive, an emulated acceleration of the locomotive, or any combination thereof and ii) location data representing at least one of the following: an emulated location or position of the locomotive, an emulated location or position of a train including the locomotive, an emulated location or position of at least one railroad car of the train, or any combination thereof.

In one preferred and non-limiting embodiment or aspect, the emulation circuitry is programmed or configured to emulate at least one operation of a locomotive control circuit of a locomotive equipped with 26L type air brake system and a DC traction type propulsion system.

In one preferred and non-limiting embodiment or aspect, the emulation circuitry is programmed or configured to emulate at least one operation of a locomotive control circuit of a locomotive equipped with a Locomotive Systems Integration (LSI) protocol electronic air brake system and an AC traction type propulsion system.

In one preferred and non-limiting embodiment or aspect, the emulation circuitry is programmed or configured to emulate at least one operation of a locomotive control circuit of a locomotive equipped with a locomotive interface gateway (LIG).

In one preferred and non-limiting embodiment or aspect, provided is a computer-implemented locomotive control signal generation method for emulating at least one operation of at least one locomotive control circuit, the method comprising: determining or receiving user input; and based at least partially on the user input, generating at least one control signal for controlling at least one of the following onboard locomotive subsystems: a propulsion system, a train line control system, an air brake system, a dynamic braking system, a head of train (HOT) system, an end of train telemetry (EOT) system, a 4-Aspect cab signaling system, a positive train control (PTC) system, an event recorder system, or any combination thereof.

In one preferred and non-limiting embodiment or aspect, provided is a non-transitory computer-readable medium including computer-executable instructions which when executed on one or more computers emulate at least one operation of at least one locomotive control circuit which performs the acts comprising: determining or receiving user input; and based at least partially on the user input, generating at least one control signal for controlling at least one of the following onboard locomotive subsystems: a propulsion system, a train line control system, an air brake system, a dynamic braking system, a head of train (HOT) system, an end of train telemetry (EOT) system, a 4-Aspect cab signaling system, a positive train control (PTC) system, an event recorder system, or any combination thereof.

Further preferred and non-limiting embodiments or aspects will not be described and set forth in the following numbered clauses:

Clause 1. A locomotive control signal generator comprising: emulation circuitry for emulating at least one operation of at least one locomotive control circuit, wherein the emulation circuitry is programmed or configured to: determine or receive user input; and based at least partially on the user input, generate at least one control signal for controlling at least one of the following onboard locomotive subsystems: a propulsion system, a train line control system, an air brake system, a dynamic braking system, a head of train (HOT) system, an end of train telemetry (EOT) system, a 4-Aspect cab signaling system, a positive train control (PTC) system, an event recorder system, or any combination thereof.

Clause 2. The locomotive control signal generator of clause 1, wherein the emulation circuitry is programmed or configured to determine or receive at least one output signal from the at least one onboard locomotive subsystem.

Clause 3. The locomotive control signal generator of clause 2, wherein the emulation circuitry is programmed or configured to generate the at least one control signal based at least partially on the at least one output signal.

Clause 4. The locomotive control signal generator of any of clauses 2 or 3, wherein the at least one output signal comprises data representing an event recorder file.

Clause 5. The locomotive control signal generator of clause 4, wherein the emulation circuitry is programmed or configured to replicate conditions present in one or more locomotive control circuits of a locomotive at a selected period of time based at least partially on the data representing the event recorder file.

Clause 6. The locomotive control signal generator of clause 5, wherein the conditions include at least one error or failure condition of the one or more locomotive control circuits of the locomotive.

Clause 7. The locomotive control signal generator of any of clauses 2-6, wherein the at least one output signal comprises data representing a track database file.

Clause 8. The locomotive control signal generator of clause 7, wherein the emulation circuitry is programmed or configured to generate the at least one control signal in a National Marine Electronics Association (NMEA) format based at least partially on the data representing the track database file.

Clause 9. The locomotive control signal generator of any of clauses 1-8, wherein the emulation circuitry is programmed or configured to generate the at least one control signal as one of a digital signal, an analog signal, a frequency signal, and a serial communications signal.

Clause 10. The locomotive control signal generator of any of clauses 1-9, wherein the emulation circuitry is programmed or configured to modify the emulation of the at least one operation of the at least one locomotive control circuit to simulate at least one failure of the locomotive control circuit.

Clause 11. The locomotive control signal generator of any of clauses 1-10, wherein the emulation circuitry simultaneously emulates operations of a plurality of locomotive control circuits, and wherein the emulation circuitry is programmed or configured to generate a plurality of control signals for controlling a plurality of onboard locomotive subsystems.

Clause 12. The locomotive control signal generator of any of clauses 1-11, wherein the emulation circuitry is programmed or configured to provide a user interface configured to determine or receive the user input and provide an output of locomotive operational information.

Clause 13. The locomotive control signal generator of clause 12, wherein the user interface comprises at least one emulated locomotive control configured to be actuated by a user.

Clause 14. The locomotive control signal generator of clause 13, wherein the at least one emulated locomotive control comprises at least one of the following: a master controller reverser position control, a master controller throttle position control, an automatic brake control, an independent brake control, a feed valve settings control, an air brake cut in and cut out actuation control, an engine control switch, a cab signal cut in and cut out switch, a cab signal depart test switch, a horn switch, a generator field switch, an engine run switch, a wheel slip test switch, a manual sand switch, an alerter reset switch, or any combination thereof.

Clause 15. The locomotive control signal generator of any of clauses 12-14, wherein the output of locomotive operational information comprises at least one of the following: at least one emulated air brake gauge indicating at least one of a main reservoir pressure, a brake pipe pressure, an equalizing reservoir pressure, and a brake cylinder pressure, an emulated load meter, an emulated 4 aspect cab signal display, an emulated head of train device with read out, an emulated speedometer, an emulated wheel slip indicator, an emulated process control system (PCS) open indicator, or any combination thereof.

Clause 16. The locomotive control signal generator of any of clauses 12-15, wherein the emulation circuitry comprises a processor configured to control a display to provide the user interface to the user and execute locomotive logic to emulate the at least one operation of the at least one locomotive control circuit and at least one programmable logic controller (PLC) configured to drive the at least one locomotive control subsystem with the at least one control signal based at least partially on the emulation of the at least one operation of the at least one locomotive control circuit.

Clause 17. The locomotive control signal generator of any of clauses 1-16, wherein the at least one control signal comprises at least one of i) movement data representing at least one of the following: an emulated speed of the locomotive, an emulated acceleration of the locomotive, or any combination thereof and ii) location data representing at least one of the following: an emulated location or position of the locomotive, an emulated location or position of a train including the locomotive, an emulated location or position of at least one railroad car of the train, or any combination thereof.

Clause 18. The locomotive control signal generator of any of clauses 1-17, wherein the emulation circuitry is programmed or configured to emulate at least one operation of a locomotive control circuit of a locomotive equipped with 26L type air brake system and a DC traction type propulsion system.

Clause 19. The locomotive control signal generator of any of clauses 1-18, wherein the emulation circuitry is programmed or configured to emulate at least one operation of a locomotive control circuit of a locomotive equipped with a Locomotive Systems Integration (LSI) protocol electronic air brake system and an AC traction type propulsion system.

Clause 20. The locomotive control signal generator of any of clauses 1-19, wherein the emulation circuitry is programmed or configured to emulate at least one operation of a locomotive control circuit of a locomotive equipped with a locomotive interface gateway (LIG).

Clause 21. A computer-implemented locomotive control signal generation method for emulating at least one operation of at least one locomotive control circuit, the method comprising: determining or receiving user input; and based at least partially on the user input, generating at least one control signal for controlling at least one of the following onboard locomotive subsystems: a propulsion system, a train line control system, an air brake system, a dynamic braking system, a head of train (HOT) system, an end of train telemetry (EOT) system, a 4-Aspect cab signaling system, a positive train control (PTC) system, an event recorder system, or any combination thereof.

Clause 22. A non-transitory computer-readable medium including computer-executable instructions which when executed on one or more computers emulate at least one operation of at least one locomotive control circuit which performs the acts comprising: determining or receiving user input; and based at least partially on the user input, generating at least one control signal for controlling at least one of the following onboard locomotive subsystems: a propulsion system, a train line control system, an air brake system, a dynamic braking system, a head of train (HOT) system, an end of train telemetry (EOT) system, a 4-Aspect cab signaling system, a positive train control (PTC) system, an event recorder system, or any combination thereof.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS AND APPENDICES

FIG. 1A is a schematic view of a train control system that can be used in connection with a locomotive control signal generator according to principles of the present invention;

FIG. 1B is a schematic view of one embodiment of a train control system that can be used in connection with a locomotive control signal generator according to principles of the present invention;

FIG. 1C is a schematic drawing of a locomotive control signal generator according to principles of the present invention;

FIG. 2 is a schematic drawing of one embodiment of a locomotive control signal generator including a programmable logic controller layer according to principles of the present invention;

FIG. 3 is a perspective view of an example user interface according to principles of the present invention;

FIG. 4 is a perspective view of a locomotive control signal generator according to principles of the present invention; and

FIG. 5 is a schematic drawing of example protocols for a Locomotive Interface Gateway (LIG) to Positive Train Control (PTC) application interface according to principles of the present invention.

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. It is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As used herein, the terms “communication” and “communicate” refer to the receipt, transmission, or transfer of one or more signals, messages, commands, or other type of data. For one unit or device to be in communication with another unit or device means that the one unit or device is able to receive data from and/or transmit data to the other unit or device. A communication may use a direct or indirect connection, and may be wired and/or wireless in nature. Additionally, two units or devices may be in communication with each other even though the data transmitted may be modified, processed, routed, etc., between the first and second unit or device. For example, a first unit may be in communication with a second unit even though the first unit passively receives data, and does not actively transmit data to the second unit. As another example, a first unit may be in communication with a second unit if an intermediary unit processes data from one unit and transmits processed data to the second unit. It will be appreciated that numerous other arrangements are possible. Any known electronic communication protocols and/or algorithms may be used such as, for example, TCP/IP (including HTTP and other protocols), WLAN (including 802.11 and other radio frequency-based protocols and methods), analog transmissions, and/or the like. It is to be noted that a “communication device” includes any device that facilitates communication (whether wirelessly or hard-wired (e.g., over the rails of a track)) between two units, such as two locomotive units or control cars. In one preferred and non-limiting embodiment or aspect, the “communication device” is a radio transceiver programmed, configured, or adapted to wirelessly transmit and receive radio frequency signals and data over a radio signal communication path.

The present invention, including the various computer-implemented and/or computer-designed aspects and configures, may be implemented on a variety of computing devices and systems, wherein these computing devices include the appropriate processing mechanisms and computer-readable media for storing and executing computer-readable instructions, such as programming instructions, code, and the like. In addition, aspects of this invention may be implemented on existing controllers, control systems, and computers integrated or associated with, or positioned on, a locomotive or control car and/or any of the railroad cars. For example, the presently-invented system or any of its functional components can be implemented wholly or partially on a train management computer, a Positive Train Control computer, an on-board controller or computer, a railroad car computer, and the like. In addition, the presently-invented systems and methods may be implemented in a laboratory environment in one or more computers or servers. Still further, the functions and computer-implemented features of the present invention may be in the form of software, firmware, hardware, programmed control systems, microprocessors, and the like.

The locomotive control signal generator and computer-implemented method described and claimed herein may be implemented in connection with a variety of systems and vehicular networks; however, the systems and methods described herein are particularly useful in connection with a railway system and network. Accordingly, the presently-invented methods and systems can be implemented in connection with various known train control and management systems, e.g., the I-ETMS® of Wabtec Corp. The systems and methods described herein are useful in connection with emulating the operations of one or more locomotives or control cars that make up a train. It should be noted that multiple locomotives or control cars may be included in the emulated train to facilitate the reduction of the train to match with passenger (or some other) demand or requirement. Further, the method and systems described herein can be used in connection with commuter trains, freight trains, push-pull train configurations, and/or other train arrangements and systems. Still further, the emulated train operations may be separated into different configurations (e.g., other trains) and movement emulated in either the first direction A and/or the second direction B. Any configuration or arrangement of locomotives, control cars, and/or railroad cars may be designated as a train and/or a consist. Still further, it is to be expressly understood that the presently-invented methods and systems described herein may be used in connection with an auxiliary vehicle, such as an auxiliary railroad vehicle, a maintenance vehicle or machine, a road vehicle (e.g., truck, pick-up truck, car, or other machine), a vehicle equipped to ride on the rails of the track, and/or the like.

In one preferred and non-limiting embodiment or aspect, the methods and systems described herein are used in connection with emulated locomotives or controls cars that are positioned on each end of the train, while in other preferred and non-limiting embodiments, the methods and systems described herein are used in connection with locomotives or control cars that are positioned intermediately in the train (since these intermediate locomotives or control cars may eventually become a controlling locomotive or control car when the train is reconfigured). It is also noted that the methods and systems described herein may be used in connection with “electrical multiple unit” (EMU) or “diesel multiple unit” (DMU) configurations, where a locomotive does not technically exist, but multiple control cars would still be present. Still further, the emulated train may include only one locomotive or control car and/or some or no railroad cars. Also, as discussed above, the methods and systems described herein may be used in connection with any vehicle type operating in the railway network.

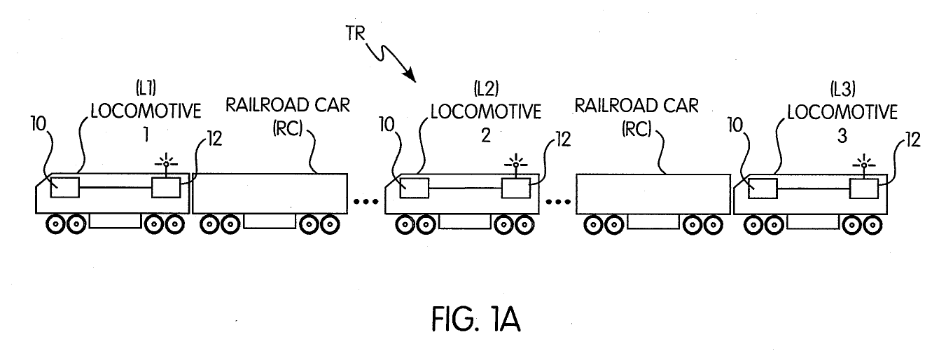

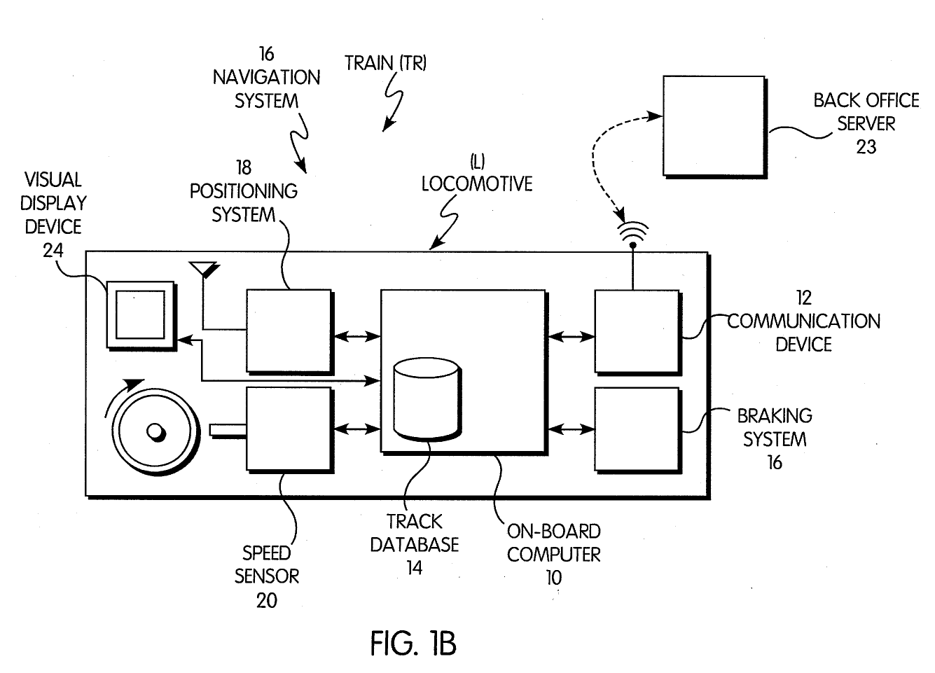

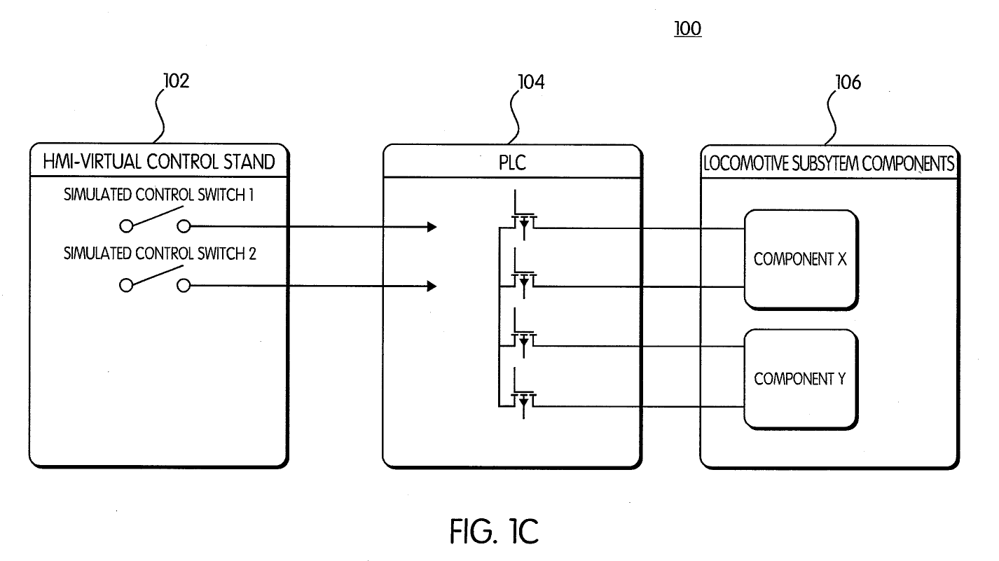

With specific reference to FIGS. 1A and 1B, and in one preferred and non-limiting embodiment or aspect, provided is a locomotive control signal generator and computer-implemented method that may be implemented with respect to locomotive subsystems in a laboratory environment or on an emulated train (TR) including at least one locomotive or control car (L) and, optionally, one or more railcars (RC). For example, in one implementation, the emulated train (TR) may include a plurality of locomotives (L1, L2, L3) and a plurality of rail cars (RC). In another implementation, the emulated train (TR) may include only a single locomotive (L) and no rail cars (RC). The locomotive(s) (L) are equipped with at least an on-board computer 10 (e.g., an on-board controller, a train management computer, an on-board processor, and/or the like) programmed or configured to implement or facilitate at least one train action and a communication device 12 in communication with the on-board computer 10 and programmed or configured to receive, transmit, and/or process data signals. While the communication device 12 may be in the form of a wireless communication device (as illustrated in FIG. 1B), as discussed herein, this communication device 12 may also be programmed or configured to transmit, process, and/or receive signals over a trainline, using an ECP component, over the rails, and/or the like.

A locomotive control signal generator and computer-implemented method may be used in connection with and transmit and/or receive control signals and/or train data to and/or from at least some of the following locomotive subsystems: the train management computer or on-board computer 10 (which performs calculations for or within the Positive Train Control (PTC) system, including navigation and enforcement calculations); the communication device 12 (or data radio) (which may be used to facilitate the communications between the on-board computers 10 in one or more of the locomotives or control cars (L) of a train (TR), communications with a wayside device, e.g., signals, switch monitors, wayside devices, and the like, and/or communications with a remote server, e.g., a back office server 23, a central controller, central dispatch, and/or); a track database 14 (which may include information about track positions or locations, switch locations, crossing locations, track heading changes, e.g., curves, distance measurements, train information, e.g., the number of locomotives or control cars (L), the number of railcars (RC), the number of conventional passenger cars, the number of control cars, the total length of the train (TR), the specific identification numbers of each locomotive or control car (L) where PTC equipment (e.g., an on-board computer 10) is located, and the like); a navigation system 16 (optionally including a positioning system 18 (e.g., a Global Positioning System (GPS)) and/or a wheel tachometer/speed sensor 20), such as in a PTC-equipped locomotive or control car (L); and a visual display device 24 (or operator interface), typically located in the locomotive or control car (L), which is in direct or indirect communication with the on-board computer 10 and provides information and data to the operator, such as the information, data, and/or screens as discussed hereinafter. It should also be recognized that some or all of the steps and processing described herein may be performed locally by the on-board computer 10 of the locomotive or control car (L), or alternatively, by another computer (e.g., a computer associated with the end-of-train unit, a computer associated with a wayside device, and the like) and/or a remote computer or server (e.g., the back office server 23, a remote computer or server associated with central dispatch, a central controller, a computer-aided dispatch system, and intermediate control computer, and the like).

Further, and as discussed, the on-board computer 10 includes or is in communication with the communication device 12 (e.g., a data radio, a communication interface, a communication component, and/or the like), which facilitates communication by or between locomotives or control cars (L) and/or the locomotive or control car (L) and some remote server or computer system, e.g., a central controller, a back office server 23, a remote server, central dispatch, back office PTC components, various wayside devices, such as signal or switch monitors, or other on-board computers 10 in the railway system. Further, this communication may occur wirelessly or in a “hard wired” form, e.g., over the rails of the track.

As discussed, the on-board computer 10 may be located at any position or orientation on the train (TR), and the on-board computer 10 (or on-board controller, on-board computer system, train management computer, and/or the like, and which performs the determinations and/or calculations for the Positive Train Control (PTC) system) includes or is in communication with the track database 14 populated with data and/or which receives specified data and information from other trains, remote servers, back office servers 23, central dispatch, and/or the like, where this data may include track profile data, train data, information about switch locations, track heading changes (e.g., curves, and distance measurements), train consist information (e.g., the number of locomotives, the number of cars, the total length of the train (TR)), and/or the like. Of course, it is envisioned that any type of train management system can be used within the context and scope of the present invention.

In one preferred and non-limiting embodiment or aspect, and as illustrated in FIG. 1C, the system architecture used to support the functionality of at least some of the methods and systems described herein includes a locomotive control signal generator (LCSG) 100 that includes a human-machine interface (HMI) 102, a programmable logic controller (PLC) layer (104), and a locomotive subsystem components layer 106.

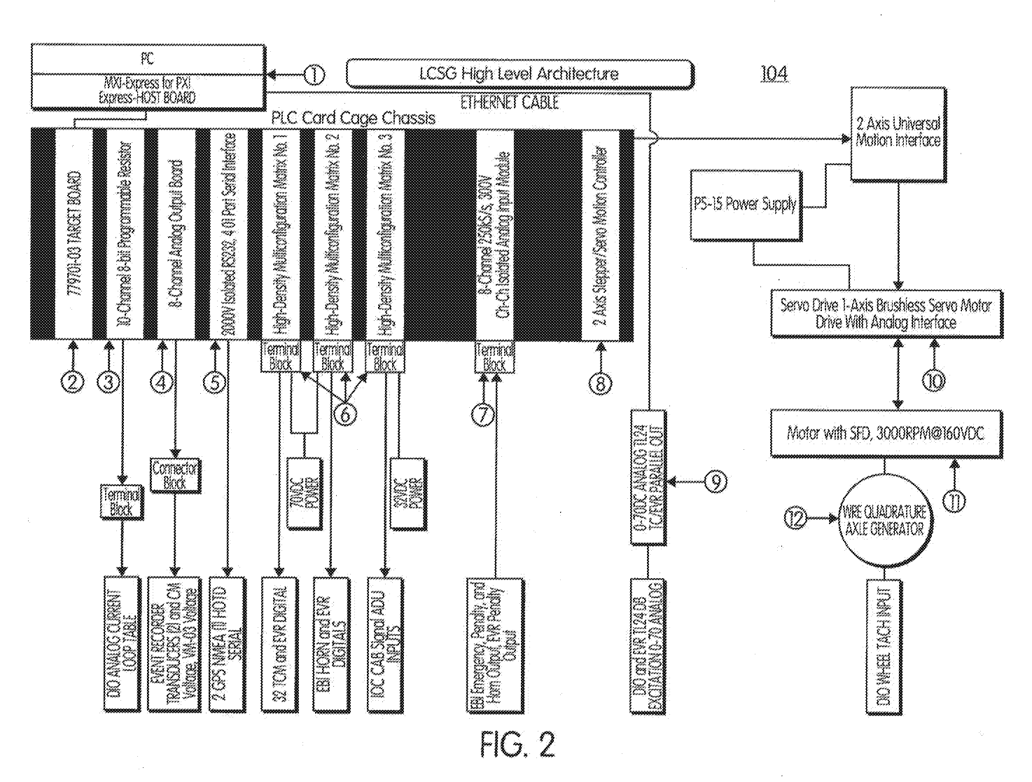

FIG. 2 is a schematic drawing showing details of the PLC layer 104 of the LCSG 100. A personal computer (PC) 1 can store and execute software for controlling the HMI 102 and emulating locomotive control circuits, and includes an express PC Host board that communicates with a PLC card cage chassis including a plurality of programmable logic controllers (PLCs). For example, the PC 1 and the PLCs can provide emulation circuitry programmed or configured to emulate locomotive control circuits. The PC 1 can execute the software based on locomotive logic to emulate the locomotive control circuits based on user input received from the HMI 102 and output signals received from the onboard locomotive hardware and subsystems, and control the PLCs to generate control signals to drive the onboard locomotive hardware and subsystems.

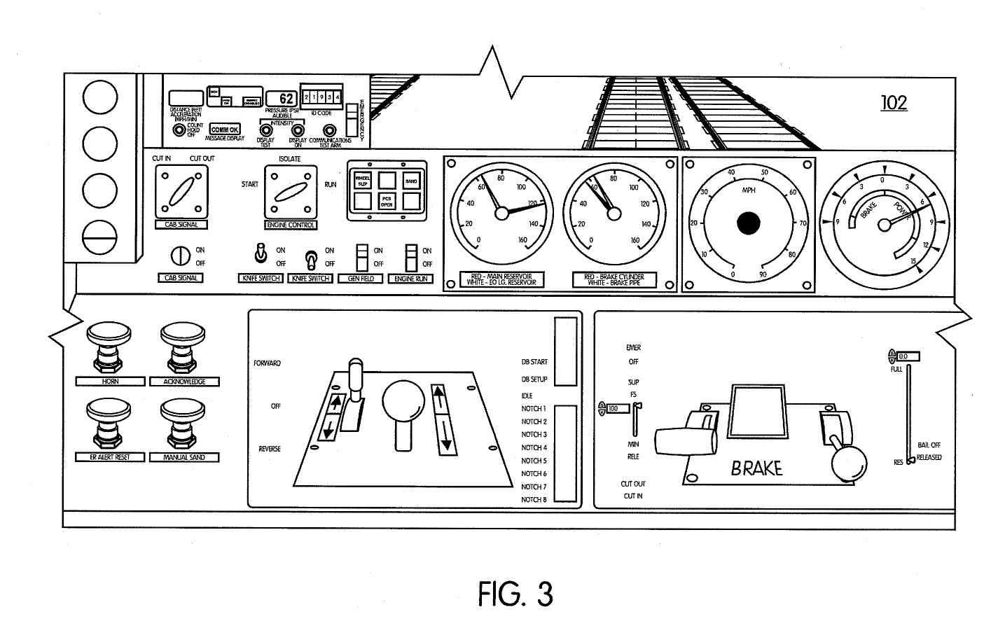

The HMI 102 comprises a user interface configured to determine or receive user input from a user and provide an output of locomotive operational information. For example, the emulation circuitry, such as the PC 1 and/or one or more physical locomotive controls, is programmed or configured to provide the user interface to determine or receive the user input from the user. The user interface comprises at least one emulated locomotive control configured to be actuated by a user. For example, the at least one emulated locomotive control comprises at least one of the following: a master controller reverser position control, a master controller throttle position control, an automatic brake control, an independent brake control, a feed valve settings control, an air brake cut in and cut out actuation control, an engine control switch, a cab signal cut in and cut out switch, a cab signal depart test switch, a horn switch, a generator field switch, an engine run switch, a wheel slip test switch, a manual sand switch, an alerter reset switch, or any combination thereof. As described in more detail herein, the emulated locomotive controls can comprise software based touchscreen interfaces and/or physical locomotive controls designed to simulate an actual locomotive cab environment, such as a physical mechanical throttle handle. FIG. 3 illustrates various example locomotive controls provided by physical switches or levers and other controls provided via a graphical user interface (GUI) on a display.

The HMI 102 can enable the user to interface with a simulated locomotive control stand via the PC 1 in a manner consistent with that of a locomotive operator interfacing with an actual locomotive operating in revenue service. For example, the HMI 102 can include a supplemental control window that displays percentages and positions of the above-noted controls to the user as feedback to actual percentages and positions selected by the user. In another embodiment or aspect, the HMI 102 can include in the supplemental control window up and down arrows to “bump” one or more of the controls for more finite movement thereof, e.g., for more finite movement of a master controller throttle handle, a master controller reverse handle, an independent brake handle (e.g., in 5% increments), and an automatic brake handle (e.g., detent positions/5% increments).

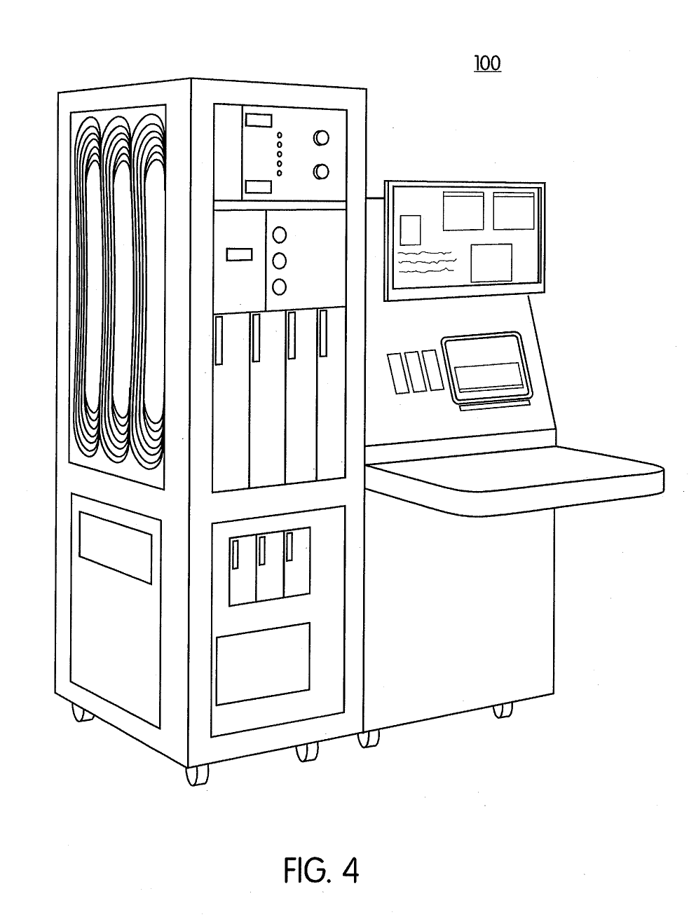

In one preferred and non-limiting embodiment or aspect, at least a portion of the HMI 102 is provided as a user interface via a display, e.g., a typical desktop monitor or touchscreen interface. The display can include any locomotive control and may be situated similar to a freight locomotive operators cab. In another example, at least a portion of the locomotive controls are mechanically or electromechanically provided, e.g., a throttle lever, and when mechanically or electromechanically actuated by the user cause the HMI 102 to receive or determine the user input via the mechanical or electromechanical actuation. For example, the HMI 102 is programmed or configured to resemble a typical locomotive control stand, such as the embodiment shown in FIG. 3, with some locomotive control provided by physical switches or levers and other controls provided via a graphical user interface (GUI) on a display. FIG. 4 is a perspective view of one preferred and non-limiting embodiment or aspect of a locomotive control signal generator.

A user can actuate the locomotive controls in the HMI 102 to provide the user input, and the PLC layer 104 can drive physical outputs or control signals that can be monitored by many different types of onboard locomotive hardware and subsystems in response to the user input. For example, the PLC layer 104 can respond based on the logic of the combination of actuated controls to emulate the functions and/or operations an actual locomotive control system performs in response to the combination of controls. In an example, the onboard locomotive hardware and subsystems can include onboard Positive Train Control (PTC), a PTC Crash Hardened Memory module, an actual automatic engine restart system, a cab signal system, a diesel engine control system, and a locomotive event recorder. However, example embodiments are not limited thereto and the LCSG 100 can be configured to send signals to any onboard locomotive hardware or subsystem.

The HMI 102 can command system output and deliver locomotive operational information to the user, such as indicator lights, meter readings, and audible warnings. In an example, the output of locomotive operational information provided to the user via the HMI 102, which is determined by the emulation circuitry of the PLC layer 104 based on the user input, the control signals sent to the onboard locomotive hardware and subsystems, and the output signals received from the onboard locomotive hardware and subsystems, can include at least one of the following: at least one emulated air brake gauge indicating at least one of a main reservoir pressure, a brake pipe pressure, an equalizing reservoir pressure, and a brake cylinder pressure, an emulated load meter, an emulated 4-aspect cab signal display, an emulated head of train device with read out, an emulated speedometer, an emulated wheel slip indicator, an emulated process control system (PCS) open indicator, or any combination thereof. For example, the output of locomotive operational information determined by the emulation circuitry and provided to the user via the HMI 102 can correspond to a response to the user input, the control signals, and the output signals that would be provided by an actual locomotive in revenue service.

As discussed above, the software and hardware providing the HMI 102 and the locomotive logic that determines the associated driven output sequence and/or control signal values can be housed in the PC 1. For example, the emulation circuitry comprises a processor programmed or configured to control a display to provide the user interface to the user and execute locomotive logic to emulate the operations of locomotive control circuits and at least one programmable logic controller (PLC) programmed or configured to drive onboard locomotive hardware and subsystems with control signals based on the emulation of the operations of the onboard locomotive control circuits. The PC 1 can receive the user input from the user via the HMI 102 and translate the combination of control lever and switch positions to a combination of locomotive control output electrical signals. Commands with the corresponding signal to drive are sent from the PC 1, to individual PLC cards in the PLC card cage chassis as shown in FIG. 2. For example, there are a wide variety of signal types, and one or more PLC cards can be assigned for each signal type. The PLC layer 104 monitors output signals from the applied onboard locomotive hardware and subsystem output controls and reacts based on known locomotive control system response logic, which can cause the PLC layer 104 to modify its own output circuits.

The PLC layer 104 can generate, based on the user input, the control signals, and/or the output signals at least one control signal for controlling at least one of the following onboard locomotive subsystems: a propulsion system, a train line control system, an air brake system, a dynamic braking system, a head of train (HOT) system, an end of train telemetry (EOT) system, a 4-Aspect cab signaling system, a positive train control (PTC) system, an event recorder system, or any combination thereof. For example, the PLC layer 104 can comprise hardware, such as the PC 1 and the PLC cards, that translates the user input into electrical and physical outputs. For example, the emulation circuitry of the PLC layer 104 can be programmed or configured to generate the at least one control signal as one of a digital signal, an analog signal, a frequency signal, and a serial communications signal. The PLC layer 104 can deliver the control signals to the onboard locomotive hardware and subsystem components layer 106 in the same logic that a locomotive would deliver control signals during revenue service to provide an emulated locomotive environment. In some embodiments, the emulation circuitry simultaneously emulates operations of a plurality of different locomotive control circuits, and the emulation circuitry is programmed or configured to generate a plurality of different control signals for controlling a plurality of different onboard locomotive hardware and subsystems.

Referring again to FIG. 2, the system architecture used to support the functionality of at least some of the methods and systems described herein includes a target board 2 in the PLC card cage chassis can be configured to translate and route messages bound to each card within the PLC card cage chassis. For example, the target board 2 can translate messages from the PC 1 emulating the operations and outputs of various locomotive control circuits described herein into the appropriate format(s) for controlling the PLCs to generate the control signals to drive the onboard locomotive hardware and subsystems, and route the messages to the appropriate PLC(s) configured to drive the onboard locomotive hardware and/or subsystems according to the emulated operations and outputs. A programmable resistor board 3 can be configured to execute varying resistance values of various analog current loop circuits that are monitored by onboard locomotive hardware and subsystems, such as a PTC system. For example, the individual channels of the programmable resistor board 3 can be varied to emulate various locomotive system pressures, which are monitored by the by onboard locomotive hardware and subsystems, such as the PTC system. In one embodiment, the programmable resistor board 3 is configured to use a 10-Channel 8-bit programmable resistor to execute varying resistance values of a digital input output (DIO) analog current loop table. An analog output board 4 is programmed or configured to deliver analog voltage values to various sensors as part of the onboard locomotive hardware and subsystems, such as the PTC and Event Recorder systems. For example, the analog voltage values can be varied to emulate transducers connected to various air brake pneumatic circuits that deliver input values to voltage and current sensors monitored by the PTC system using event recorder transducers and a current module (CM), which can be a sensor that monitors current passing through a single traction motor circuit as part of the locomotive propulsion system. The analog output board 4 controls the output to emulate the varying amount of current that the locomotive is producing for tractive effort based on operator selected input. In one embodiment, the analog output board 4 comprises an 8 channel analog output board. A RS-232 serial interface card 5 sends serial data to the onboard locomotive hardware and subsystems, such as the PTC and Event Recorder systems. For example, the PTC system can receive duplicate National Marine Electronics Association (NMEA) standardized GPS serial messages to emulate a GPS receiver sending time, speed, and position data to emulate locomotive movement. The event recorder can receive emulated head-of-train device (HOTD) serial messages from the event recorder and PTC system from the serial interface card 5. In one embodiment, the RS-232 serial interface card 5 comprises a 2000V Isolated RS232, 4 01 Port Serial Interface. 100701 A plurality of multi-configuration matrix boards 6 are configured to deliver digital signals to the onboard locomotive hardware and subsystems, such as the PTC and Event Recorder systems, in corresponding locomotive logic as actuated by the user via the HMI 102. For example, a first multi-configuration matrix board can output 32 TMC and an EVR digital signals, for example forward and reverse signals, which can be digital 70V DC outputs that are driven based on user HMI control actuation bound for the PTC and Event recorder systems. The user HMI control can include any combination of throttle handle, reverser handle, and individual switch activation received via the HMI 102. A second multi-configuration matrix board can output EBI HORN and EVR digital signals, which can be digital 70V DC outputs that are driven based on user HMI control selection bound for the event recorder. The EBI Horn and EVR digital signals can be attributed to air brake pressure switch actuation and passenger transit car monitoring applicators, and can include a Lead/Trail signal, a Train Separation signal, an Actuating Pipe signal, an EIE signal, an ER Equalizing Reservoir Switch signal, an ER BC Switch signal, an ER Zero Speed Bypass signal, and an ER OS MAG Valve signal. A third multi-configuration matrix board can output a 32V DC CAB signal IOC, which can be a 32V DC matrix board utilized to emulate aspect indications of a cab signal system. For example, the 32V DC CAB signal can represent the Cab Signal ADU lights in the HMI 102 and include signals, such as CCS Restricting+, CCS Advance Approach+, CCS Approach+, CCS Clear+. An analog input board 7 is programmed or configured to monitor output signals of the onboard locomotive hardware and subsystems, such as the PTC and Event Recorder/Vigilance systems, so that the LCSG 100 can respond to commands, such as braking commands, from said systems. For example, the analog input board 7 can receive an EBI emergency signal, a Penalty signal, a Horn output signal, and an EVR Penalty output signal. These signals are output control circuits from the PTC and event recorder systems. The PLC/Software monitors these outputs and responds to their commands to alter the outputs of the PLC/Software. The PTC Penalty Magnet valve tells the PLC/Software to modify braking and propulsions system values based on this input. The Emergency Magnet Valve tells the PLC/Software to modify braking and propulsions system values based on this input. The Horn Magnet Valve tells the PLC/Software to play horn sound upon input activation. The Event Recorder Penalty Magnet Valve tells the PLC/Software to modify braking and propulsions system values based on this input. In one embodiment, the analog input board 7 can comprise an 8-Channel, 250 kS/s, 300V Ch-Ch Isolated Analog Input Module. In some example, a PLC digital input/output board (not shown) may be programmed or configured to deliver frequency output signals to the onboard locomotive hardware and subsystems, such as the PTC and Event Recorder systems; however these features may be incorporated in the axis server motor controller 8 discussed herein. An analog parallel output 9 can include an Ethernet connected programmable power supply that produces 0-70V DC analog values based on HMI handle position to the PTC and Event Recorder systems. An axis servo motor controller 8 is programmed or configured to control the output of a servo motor drive 10, which in turn drives a servo motor 11 that rotates a locomotive axle generator 12 to deliver speed information to the onboard locomotive hardware and subsystems, such as the PTC and Event Recorder systems, in the form of an active quadrature frequency output.

The onboard locomotive hardware and subsystem components layer 106 is programmed or configured to receive the control signals from the PLC layer 104. The onboard locomotive hardware and subsystem components are programmed or configured to function and operate in the same manner as the components function and operate when implemented on an actual locomotive when the logic delivery from the HMI 102 and the PLC layer 104 are representative of a fully functioning locomotive. The LCSG 100 can drive one or more of the following outputs in response to the user input via the HMI 102 and the output signals from the onboard locomotive hardware and subsystems: Forward, Reverse, Engine Run, Gen Field, Throttle A, Throttle B, Throttle C, Throttle D, DB Set UP, DB Start, PCS, Knife Switch, EC Run, EC Isolate, Wheel Slip, Sand, AB Cutin/out, TM Current, Main Gen Voltage, Wheel Tachometer A, Wheel Tachometer B, Brake Pipe I, Brake Pipe 2, Brake Cylinder, Equalizing Reservoir, Atmospheric, DB Excitation, EOT Brake Pipe Pressure, EOTMoving, EOT Marker Status, EOTNoComm, GPS1 NMEA Messages, GPS2 NMEA Messages, CCS RST+, CCSADV APP+, CCS APP+, CCS CLR+, CCSC/O+, CCSPARC/O+, Horn Button, ER Forward, ER Reverse, ER Gen Field, ER Throttle A, ER Throttle B, ER Throttle C, ER Throttle D, ERDB Set UP, ER PCS, ER Manual Sand, ER Alerter Reset, Lead/Trail, Train Separation, Actuating Pipe, EIE, ER DB Excitation, ER Brake Pipe, ER Brake Cylinder, ER penalty MV, or any combination thereof. These outputs are a set of signals for a 26L locomotive equipped with PTC and an event recorder and are publically defined by Wabtec Corp. Some of these outputs are publically defined by the AAR. For example the cab signal aspect outputs are a typical 4 aspect cab signal system. These controls signals are driven by the PLCs to emulate the locomotive environment to provide monitoring onboard locomotive hardware and subsystems the same signals as are expected during revenue operation of an actual locomotive. For example, locomotive acceleration and speed values based on a summation of forces applied by the emulation circuitry can provide a realistic emulated operation of the locomotive from a user selected starting point on a track. In another example, the at least one control signal comprises at least one of i) movement data representing at least one of the following: an emulated speed of the locomotive, an emulated acceleration of the locomotive, or any combination thereof and ii) location data representing at least one of the following: an emulated location or position of the locomotive, an emulated location or position of a train including the locomotive, an emulated location or position of at least one railroad car of the train, or any combination thereof.

The emulation circuitry of the PLC layer 104 may be programmed or configured to determine or receive the output signals from the locomotive subsystem components layer 106. In one example, the PLC layer 104 is programmed or configured to receive data representing an event recorder file. For example, PLC layer 104 can receive a .dat file to playback an event recorded download file, which enables the emulation circuitry to recreate conditions and events that actually occurred in a locomotive during revenue service. In an example, the HMI 102 can disable the user input during the recreation so that the .dat file determines the locomotive control circuits that are generated by the emulation circuitry. In another example, the emulation circuitry in the PLC layer 104 can be programmed or configured to replicate conditions present in one or more locomotive control circuits of a locomotive at a selected period of time based on the data representing the event recorder file. For example, the conditions can include at least one error or failure condition of the one or more locomotive control circuits of the locomotive. In some examples, the emulation circuitry is programmed or configured to modify the emulation of the operations of the locomotive control circuits to simulate at least one failure of a locomotive control circuit. The emulation circuitry can inject faults into the output logic of the PLCs to in effect “break” the locomotive to simulate an onboard locomotive hardware or subsystem failure.

In another example, the PLC layer 104 is programmed or configured to receive data representing a track database file, e.g., a subdiv file. The emulation circuitry can be configured to generate the at least one control signal in a National Marine Electronics Association (NMEA) format based on the data representing the track database file. For example, a user can select a geographic location via the HMI 102 that causes the PLC layer 104 to output an associated latitude, longitude, heading, and speed in NMEA message formation to an onboard locomotive hardware and subsystem component in the layer 106.

Although disclosed and non-limiting embodiments or aspects are discussed mainly with respect to a LCSG 100 implemented with respect to a 26L Phase I version locomotive, disclosed and non-limiting embodiments or aspects are not limited thereto and the LCSG 100 can be implemented with respect to any type or version of locomotive, such as a locomotive equipped with Electronic Air Brakes where RS-422 (TIA/EIA-422 Standard via the Electronics Industries Alliance) is employed. A LCSG 100 in this configuration can have an RS-422 serial board that will transmit both ILC (Integrated Locomotive Control and EAB (Electronic Air Brake) serial data in accordance with AAR S-9101-E Locomotive System Integration (LSI) Communications.

The emulation circuitry of the PLC layer 104, for example, the PC 1 and the PLCs, can be programmed or configured to accommodate various locomotive control system types and air brake combinations that are used in the rail industry, which can each have unique signal type combinations that emulate various actual locomotives used by the railroads. In an example, the emulation circuitry of the PLC layer 104 is programmed or configured to emulate an operation of a locomotive control circuit of a locomotive equipped with 26L type air brake system and a DC traction type propulsion system. In another example, the emulation circuitry is programmed or configured to emulate an operation of a locomotive control circuit of a locomotive equipped with a Locomotive Systems Integration (LSI) protocol electronic air brake system and an AC traction type propulsion system. In still another example, the emulation circuitry is programmed or configured to emulate an operation of a locomotive control circuit of a locomotive equipped with a locomotive interface gateway (LIG). LIG is primarily an Ethernet messaging structure based on Edge Messaging Protocol (EMP) which takes the locomotive OEM proprietary control system protocol and translates it into the AAR S-9365 standard message structure. The LCSG 100 can maintain the various other signal types, such as digital, analog, frequency, and serial communications signals, as still used on the newer locomotive that it emulates for signal redundancy. For example, the LCSG 100 can emulate any of the functions or operations defined for a locomotive in the Association of American Railroads (AAR) Manual of Standards and Recommended Practices Office Architecture and Railroad Electronics Messaging Locomotive Interface Gateway (LIG) to Positive Train Control (PTC) Interface Control Document (ICD) Standard S-9365.V2.0, which is incorporated herein by reference in its entirety.

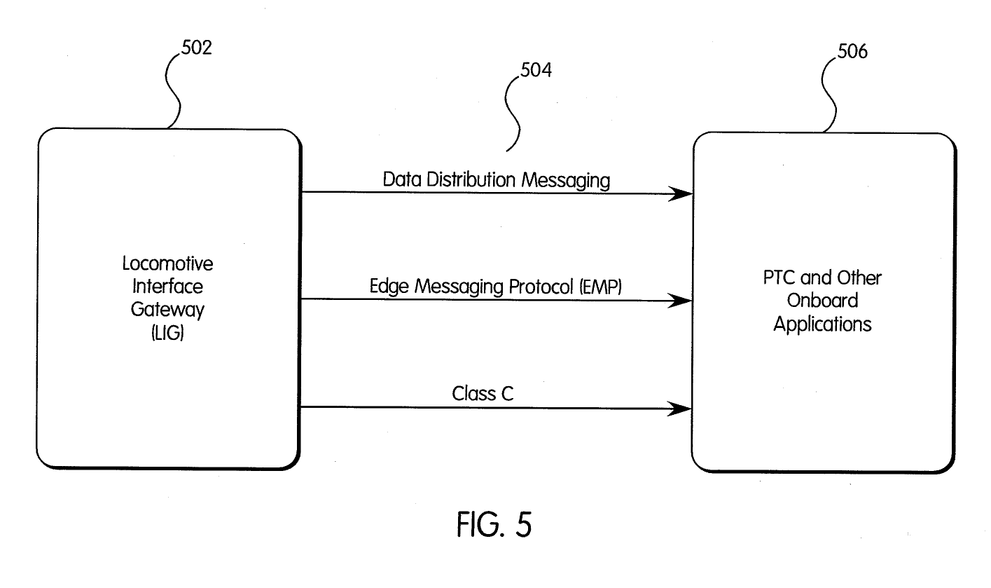

Referring to FIG. 5, the LCSG 100 can emulate a LIG 502, which can be interfaced with an application of the PTC system and/or other onboard locomotive applications or subsystems. For example, an interface 504 between the emulated LIG 502 and the PTC system 506 can occur over the S-9101 Locomotive LAN. The interface 504 between the emulated LIG 502 and the PTC system 506 comprises several layered protocols. For example, messages may be in the edge message protocol (EMP) format, and the interface 504 may use Class C messaging for unidirectional data distribution from the LIG 502 to the PTC system 506. FIG. 5 shows a Class C interface architecture for the emulated LIG 502 to Positive Train Control (PTC) application 506 interface. An LIG version of the LCSG 100 can emulate LIG messaging to connected devices, such as I-ETMS, Recorders, etc. that subscribe to the Class C broadcast message. The LCSG 100, by emulating the LIG 502, can generate control signals in the EMP format using Class C messaging for controlling the PTC system 506 and/or other onboard applications and locomotive subsystems, such as, a propulsion system, a train line control system, an air brake system, a dynamic braking system, a head of train (HOT) system, an end of train telemetry (EOT) system, a 4-Aspect cab signaling system, an event recorder system, and the like.

An LCSG 100 can be used to train mechanical repair personnel so that they can more truly comprehend how onboard locomotive systems, such as PTC and event recorder systems, behave in the field on both fully operational locomotives and on locomotives that are in a failed or problematic state. Hardware testing labs can benefit from the LCSG 100 to validate repairs or to diagnose hardware problems before applying to a locomotive for service.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A locomotive control signal generator comprising:
emulation circuitry for emulating at least one operation of at least one locomotive control circuit, wherein the emulation circuitry is programmed or configured to:
determine or receive user input; and
based at least partially on the user input, generate at least one control signal for controlling at least one of the following onboard locomotive subsystems: a propulsion system, a train line control system, an air brake system, a dynamic braking system, a head of train (HOT) system, an end of train telemetry (EOT) system, a 4-Aspect cab signaling system, a positive train control (PTC) system, an event recorder system, or any combination thereof.

2. The locomotive control signal generator of claim 1, wherein the emulation circuitry is programmed or configured to determine or receive at least one output signal from the at least one onboard locomotive subsystem.

3. The locomotive control signal generator of claim 2, wherein the emulation circuitry is programmed or configured to generate the at least one control signal based at least partially on the at least one output signal.

4. The locomotive control signal generator of claim 2, wherein the at least one output signal comprises data representing an event recorder file.

5. The locomotive control signal generator of claim 4, wherein the emulation circuitry is programmed or configured to replicate conditions present in one or more locomotive control circuits of a locomotive at a selected period of time based at least partially on the data representing the event recorder file.

6. The locomotive control signal generator of claim 5, wherein the conditions include at least one error or failure condition of the one or more locomotive control circuits of the locomotive.

7. The locomotive control signal generator of claim 2, wherein the at least one output signal comprises data representing a track database file.

8. The locomotive control signal generator of claim 7, wherein the emulation circuitry is programmed or configured to generate the at least one control signal in a National Marine Electronics Association (NMEA) format based at least partially on the data representing the track database file.

9. The locomotive control signal generator of claim 1, wherein the emulation circuitry is programmed or configured to generate the at least one control signal as one of a digital signal, an analog signal, a frequency signal, and a serial communications signal.

10. The locomotive control signal generator of claim 1, wherein the emulation circuitry is programmed or configured to modify the emulation of the at least one operation of the at least one locomotive control circuit to simulate at least one failure of the locomotive control circuit.

11. The locomotive control signal generator of claim 1, wherein the emulation circuitry simultaneously emulates operations of a plurality of locomotive control circuits, and wherein the emulation circuitry is programmed or configured to generate a plurality of control signals for controlling a plurality of onboard locomotive subsystems.

12. The locomotive control signal generator of claim 1, wherein the emulation circuitry is programmed or configured to provide a user interface configured to determine or receive the user input and provide an output of locomotive operational information.

13. The locomotive control signal generator of claim 12, wherein the user interface comprises at least one emulated locomotive control configured to be actuated by a user.

14. The locomotive control signal generator of claim 13, wherein the at least one emulated locomotive control comprises at least one of the following: a master controller reverser position control, a master controller throttle position control, an automatic brake control, an independent brake control, a feed valve settings control, an air brake cut in and cut out actuation control, an engine control switch, a cab signal cut in and cut out switch, a cab signal depart test switch, a horn switch, a generator field switch, an engine run switch, a wheel slip test switch, a manual sand switch, an alerter reset switch, or any combination thereof.

15. The locomotive control signal generator of claim 12, wherein the output of locomotive operational information comprises at least one of the following: at least one emulated air brake gauge indicating at least one of a main reservoir pressure, a brake pipe pressure, an equalizing reservoir pressure, and a brake cylinder pressure, an emulated load meter, an emulated 4 aspect cab signal display, an emulated head of train device with read out, an emulated speedometer, an emulated wheel slip indicator, an emulated process control system (PCS) open indicator, or any combination thereof.

16. The locomotive control signal generator of claim 12, wherein the emulation circuitry comprises a processor configured to control a display to provide the user interface to the user and execute locomotive logic to emulate the at least one operation of the at least one locomotive control circuit and at least one programmable logic controller (PLC) configured to drive the at least one locomotive control subsystem with the the at least one control signal based at least partially on the emulation of the at least one operation of the at least one locomotive control circuit.

17. The locomotive control signal generator of claim 1, wherein the at least one control signal comprises at least one of i) movement data representing at least one of the following: an emulated speed of the locomotive, an emulated acceleration of the locomotive, or any combination thereof and ii) location data representing at least one of the following: an emulated location or position of the locomotive, an emulated location or position of a train including the locomotive, an emulated location or position of at least one railroad car of the train, or any combination thereof.

18. The locomotive control signal generator of claim 1, wherein the emulation circuitry is programmed or configured to emulate at least one operation of a locomotive control circuit of a locomotive equipped with 26L type air brake system and a DC traction type propulsion system.

19. The locomotive control signal generator of claim 1, wherein the emulation circuitry is programmed or configured to emulate at least one operation of a locomotive control circuit of a locomotive equipped with a Locomotive Systems Integration (LSI) protocol electronic air brake system and an AC traction type propulsion system.

20. The locomotive control signal generator of claim 1, wherein the emulation circuitry is programmed or configured to emulate at least one operation of a locomotive control circuit of a locomotive equipped with a locomotive interface gateway (LIG).

21. A computer-implemented locomotive control signal generation method for emulating at least one operation of at least one locomotive control circuit, the method comprising:
determining or receiving user input; and
based at least partially on the user input, generating at least one control signal for controlling at least one of the following onboard locomotive subsystems: a propulsion system, a train line control system, an air brake system, a dynamic braking system, a head of train (HOT) system, an end of train telemetry (EOT) system, a 4-Aspect cab signaling system, a positive train control (PTC) system, an event recorder system, or any combination thereof.

22. A non-transitory computer-readable medium including computer-executable instructions which when executed on one or more computers emulate at least one operation of at least one locomotive control circuit which performs the acts comprising:
determining or receiving user input; and
based at least partially on the user input, generating at least one control signal for controlling at least one of the following onboard locomotive subsystems: a propulsion system, a train line control system, an air brake system, a dynamic braking system, a head of train (HOT) system, an end of train telemetry (EOT) system, a 4-Aspect cab signaling system, a positive train control (PTC) system, an event recorder system, or any combination thereof.
